(19) United States
(12) Patent Application Publication
(10) Pub. No.: US 2016/0157505 A1
(43) Pub. Date: Jun. 9, 2016

(54) COAGULANT COMPOSITION FOR TOFU AND PRODUCTION PROCESS OF TOFU USING THE SAME

(71) Applicant: RIKEN VITAMIN CO., LTD., Tokyo (JP)

(72) Inventors: Hirozumi TOGASHI, Chiba (JP); Kyosuke KODAMA, Chiba (JP); Shigeki ASO, Chiba (JP)

(73) Assignee: RIKEN VITAMIN CO., LTD., Tokyo (JP)

(21) Appl. No.: 14/392,195

(22) PCT Filed: Jun. 10, 2014
(86) PCT No.: PCT/JP2014/065359

§ 371 Date: Dec. 23, 2015

(30) Foreign Application Priority Data
Jun. 26, 2013 (JP) 2013-133311
Sep. 30, 2013 (JP) 2013-203431

(51) Int. Cl. A23C 20/02

(52) U.S. Cl. CPC A23C 20/025

(57) ABSTRACT

An object of the present invention is to provide a coagulant composition for tofu exhibiting high dispersibility in soy milk, even when the composition comprises a large proportion of an inorganic salt coagulant. The composition requires no use of a specially designed coagulating machine equipped with a high-speed dispersion mixer, and is thoroughly dispersed in soy milk merely by mixing with conventional low-speed stirrer. The composition coagulates soy milk to give tofu with good taste and good mouthfeel. In particular, the present invention provides a coagulant composition for tofu, the composition comprising (a) an inorganic salt coagulant, (b) a polyglycerol ester of interesterified ricinoleic acid, (c) a lecithin and/or a diacetyltartaric and fatty acid ester of glycerol and (d) an oil component.

### TECHNICAL FIELD

The present invention relates to a coagulant composition for tofu having high dispersibility in hot soy milk and to a production process of tofu using the same.

### BACKGROUND ART

Tofu, such as “firm tofu (momen-dofu)” and “silken tofu”, is conventionally produced by adding a tofu coagulant to hot soy milk usually at about 70 to 90° C. to allow the soy milk to coagulate. Tofu coagulants that have been widely used are inorganic salt coagulants such as magnesium chloride, magnesium sulfate, calcium chloride and calcium sulfate, as well as organic acids such as glucono delta-lactone. Among these, magnesium chloride has long been used as “nigari” in the production of tofu. Tofu using nigari has distinctive delicious flavor and has been favored by consumers. However, nigari gives very rapid coagulation, and therefore the use of nigari makes it difficult to produce “firm tofu” and even more difficult to produce “silken tofu”, of which the production process does not involve a secondary step of pressing in a mold. Highly professional skills are required to produce nigari silken tofu with smooth and homogeneous texture inside. Instead of nigari, calcium sulfate, which gives relatively slow coagulation, has also been widely used. However, the taste of calcium sulfate tofu is inferior to the taste of magnesium chloride tofu and is not well accepted by consumers. Another coagulant, glucono delta-lactone is easy to handle in the coagulation process and gives tofu with homogeneous texture inside. Glucono delta-lactone has come to be widely used to produce “silken tofu” and other types, but the taste of the resulting tofu is not favorable due to the remaining acidic flavor.

In industrial mass-production of “packed silken tofu (juten-dofu)”, a tofu coagulant is added to cooled soy milk usually at about 15° C. or lower prepared from hot soy milk for the purpose of preventing coagulation, then the mixture of the cooled soy milk and the coagulant is poured into a container until full, and the mixture is heated to 70° C. or higher to coagulate. This production process requires the steps of cooling of hot soy milk and reheating the cooled soy milk mixture packed in a container, and hence the energy and production efficiencies are poor.

In order to solve the above problems, various proposals have been made for providing slow-acting coagulant compositions for tofu so that the speed of coagulation can be controlled even with the use of an inorganic salt coagulant that rapidly coagulates hot soy milk.

There has been disclosed, for example, a process for producing bittern tofu, involving delaying coagulation reaction using a composition prepared by homogeneously mixing bittern with a small amount of water and with an edible fat or oil, a phospholipid, an emulsifier and boiling water (Patent Literature 1). The composition has, however, a drawback of being unstable in storage and was not widely used. Other slow-acting coagulant compositions that have been disclosed are a coagulant composition for tofu, comprising an inorganic salt coagulant for tofu, a polyglycerol ester of interesterified ricinoleic acid and a fat or oil (Patent Literature 2); a coagulant composition for tofu, prepared by dispersing an inorganic salt coagulant with a maximum particle diameter of 50 μm in an aliphatic fatty acid ester of a polyalcohol poorly soluble in water (Patent Literature 3); a water-in-oil emulsion-type coagulant composition for firm tofu, comprising a fat or oil, a polyglycerol ester of interesterified ricinoleic acid, water and a specific amount of magnesium chloride and having a specific viscosity (Patent Literature 4); a water-in-oil emulsion-type coagulant preparation for tofu, comprising specific amounts of an inorganic salt coagulant for tofu, a polyglycerol ester of interesterified ricinoleic acid, an emulsifier with a HLB of 10 or more and a fat or oil (Patent Literature 5); etc.

However, these compositions, especially when they contain a large proportion of an inorganic salt coagulant, require strong dispersing and shearing force to mix the inorganic salt coagulant in hot soy milk. Hence, the compositions require the use of a specially designed coagulating machine equipped with a high-speed dispersion mixer, which will increase the installation cost.

### CITATION LIST

### Patent Literature

Patent Literature 1: JP 62-5581 B

Patent Literature 2: JP 10-57002 A

Patent Literature 3: JP 2000-270800 A

Patent Literature 4: JP 2005-130803 A

Patent Literature 5: JP 2006-204184 A

### SUMMARY OF INVENTION

### Technical Problem

An object of the present invention is to provide a coagulant composition for tofu exhibiting high dispersibility in hot soy milk, even when the composition comprises a large proportion of an inorganic salt coagulant. The composition requires no use of a specially designed coagulating machine equipped with a high-speed dispersion mixer, and is thoroughly dispersed in hot soy milk merely by mixing with a motionless mixer, such as a conventional static mixer, or a low-speed stirrer. The composition coagulates hot soy milk to give tofu with good taste and good mouthfeel.

### Solution to Problem

The inventors conducted extensive research to solve the above problems and, as a result, found that the optimization of coagulation reaction for producing tofu will give tofu with a favorable degree of coagulation, and that the optimization will, in turn, increase the production efficiency of tofu. The inventors performed further research based on these findings and completed the present invention.

That is, the present invention include the following:

(1) a coagulant composition for tofu, the composition comprising (a) an inorganic salt coagulant, (b) a polyglycerol ester of interesterified ricinoleic acid, (c) a lecithin and/or a diacetyltartaric and fatty acid ester of glycerol and (d) an oil component;
(2) the coagulant composition for tofu according to the above (1), wherein the amount of (a) the inorganic salt coagulant relative to 100% by mass of the coagulant composition for tofu is from 16.5 to 70% by mass as calculated on the anhydrous basis;
(3) a process for producing tofu, the process comprising adding the coagulant composition for tofu according to the above (1) or (2) to hot soy milk, and
dispersing the coagulant composition for tofu in the hot soy milk with a motionless mixer or a low-speed stirrer to give a hot soy milk mixture; and
(4) a process for producing tofu, the process comprising adding the coagulant composition for tofu according to the above (1) or (2) to hot soy milk, and
dispersing the coagulant composition for tofu in the hot soy milk with a static mixer or a low-speed stirrer to give a hot soy milk mixture.

### Advantageous Effects of Invention

According to the present invention, in the production of tofu, the coagulant composition for tofu is thoroughly dispersed in hot soy milk merely with a motionless mixer, such as a conventional static mixer, or a low-speed stirrer, thereby appropriately controlling the coagulation of soy milk. The coagulant composition requires no use of a conventional, specially designed coagulating machine equipped with a high-speed dispersion mixer, and consequently the installation cost can be reduced. The coagulant composition for tofu that has been thoroughly dispersed in hot soy milk merely with a motionless mixer, such as a conventional static mixer, or a low-speed stirrer coagulates the hot soy milk to give tofu with a favorable degree of coagulation and good mouthfeel.

In particular, in the production process of packed silken tofu using 70 to 90° C. hot soy milk, cooling of hot soy milk is not required. In addition, the hot soy milk mixture containing the coagulant composition for tofu dispersed therein coagulates without being heated, and thus heating process is not necessary. Therefore, the use of the coagulant composition improves the energy efficiency and the production efficiency.

### DESCRIPTION OF EMBODIMENTS

The coagulant composition for tofu of the present invention comprises (a) an inorganic salt coagulant, (b) a polyglycerol ester of interesterified ricinoleic acid, (c) a lecithin and/or a diacetyltartaric and fatty acid ester of glycerol and (d) an oil component.

The inorganic salt coagulant of component (a) used in the present invention is, for example, magnesium chloride, magnesium sulfate, calcium chloride or calcium sulfate. These inorganic salt coagulants may be anhydrides or compounds containing water of crystallization and are not particularly limited. Specific examples thereof include magnesium chloride hexahydrate, magnesium sulfate heptahydrate, and calcium chloride dihydrate. The inorganic salt coagulants may be used alone or in combination of two or more, but in order to provide good taste tofu, preferred is magnesium chloride used alone.

The polyglycerol ester of interesterified ricinoleic acid of component (b) used in the present invention is a product of the esterification of polyglycerol with condensed ricinoleic acid, and is produced by a known esterification reaction etc. The polyglycerol may be one having an average degree of polymerization of about 2 to 15, and is preferably one having an average degree of polymerization of about 3 to 10. Specific examples of preferred polyglycerols include triglycerol, tetraglycerol and hexaglycerol. The condensed ricinoleic acid is a mixture of polycondensation products formed from ricinoleic acid by heating. The condensed ricinoleic acid may be one having an average degree of polymerization of about 2 to 10, and is preferably one having an average degree of polymerization of about 3 to 6.

The lecithin of component (c) used in the present invention is one produced from an oil seed or an animal-derived material, and is not particularly limited as long as its major component is a phospholipid. Examples thereof include liquid lecithins containing oil, such as soybean lecithin and yolk lecithin; lecithin powders, which are produced from the liquid lecithins by removing the oil followed by drying; fractionated lecithins, which are produced from liquid lecithins by fractionation and subsequent purification; enzymatically hydrolyzed lecithins and enzymatically modified lecithins, which are produced from lecithins by enzymatic treatment; etc. Preferred are liquid lecithins and enzymatically hydrolyzed lecithins.

The diacetyltartaric and fatty acid ester of glycerol of component (c) used in the present invention can typically be produced by the reaction of monoglycerides with diacetyl tartaric acid or diacetyl tartaric anhydride, or by the reaction of glycerol with diacetyl tartaric acid and fatty acids.

The diacetyltartaric and fatty acid ester of glycerol can be produced as follows. Briefly, to molten monoglycerides was added diacetyl tartaric anhydride, and the mixture is allowed to react at about 120° C. for about 90 minutes. The molar ratio of monoglycerides to diacetyl tartaric anhydride is preferably 1:1 to 1:2. The reaction is preferably performed in a reactor in which the air is replaced with inert gas to prevent coloring of the product and odor generation. The product from the monoglycerides and diacetyl tartaric anhydride is a mixture containing diacetyltartaric and fatty acid esters of glycerol as well as diacetyl tartaric acid, unreacted monoglycerides and other substances.

The fatty acids forming the diacetyltartaric and fatty acid ester of glycerol used in the invention are not particularly limited as long as they are fatty acids derived from animal and vegetable fats and oils that are edible. Example thereof include one selected from the group of caprylic acid, capric acid, lauric acid, myristic acid, palmitic acid, stearic acid, oleic acid, linoleic acid, erucic acid, etc., and a mixture of two or more of them. Preferred is oleic acid. The fatty acids used in the present invention may be saturated fatty acids or unsaturated fatty acids.

According to the present invention, the addition of component (c) to a coagulant composition for tofu preferably increases the dispersibility of the coagulant composition in hot soy milk. This significant and useful finding was discovered for the first time by the inventors during the process of developing the present invention.

The oil component of component (d) used in the present invention may be a glycerol fatty acid ester, a polyglycerol fatty acid ester, a propylene glycol fatty acid ester, or a sorbitan fatty acid ester. Preferred are those in a liquid form at normal temperature.

The glycerol fatty acid ester herein may be, for example, a monoglyceride, a diglyceride, or a triglyceride (fat or oil). The mono- and diglycerides are of high purity produced as follows: glycerol is esterified with fatty acids or transesterified with fats or oils to give a mixture of monoglycerides, diglycerides and triglycerides (fats or oils); and the mixture is subjected to separation and concentration by molecular distillation, fractional crystallization, chromatography, or other methods. The glycerol fatty acid ester may be a mixture of a monoglyceride, a diglyceride, and a triglyceride (fat or oil).

The fatty acids forming the glycerol fatty acid ester are not particularly limited as long as they are fatty acids derived from animal and vegetable fats and oils that are edible. Example thereof include one selected from caprylic acid, capric acid, lauric acid, myristic acid, palmitic acid, stearic acid, oleic acid, linoleic acid, erucic acid, etc., and a mixture of two or more of them. Preferably, the fatty acids are a fatty acid or fatty acid mixture comprising one or more selected from the group of caprylic acid, capric acid and lauric acid in an amount of about 50% by mass or more, preferably about 70% by mass or more, further more preferably about 90% by mass or more based on the total amount of the fatty acid or fatty acid mixture.

The triglyceride (fat or oil) is not particularly limited as long as it is an edible triglyceride. Examples thereof include vegetable fats and oils, such as soybean oil, rapeseed oil, cottonseed oil, safflower oil, sunflower seed oil, rice bran oil, corn oil, coconut oil, palm oil, palm kernel oil, peanut oil, olive oil, high oleic rapeseed oil, high oleic safflower oil, high oleic corn oil, and high oleic sunflower seed oil; animal fats and oils, such as beef tallow, lard, fish oil, and milk fats; those obtained by fractionating, hydrogenating or transesterificating these animal and vegetable fats and oils; medium-chain fatty acid triglycerides (MCTs); etc. Preferred are medium-chain fatty acid triglycerides (MCTs).

The polyglycerol fatty acid ester is a product of the esterification of polyglycerol with fatty acids, and is produced by a known esterification reaction etc. The polyglycerol is a mixture of polyglycerols with different degrees of polymerization produced by, typically, heating glycerol, glycidol, epichlorohydrin, or the like to allow the polycondensation reaction to proceed. Examples of the polyglycerol include polyglycerols with an average degree of polymerization of about 2 to 10, such as diglycerol (average degree of polymerization of 2), triglycerol (average degree of polymerization of 3), tetraglycerol (average degree of polymerization of 4), hexaglycerol (average degree of polymerization of 6), octaglycerol (average degree of polymerization of 8), and decaglycerol (average degree of polymerization of 10).

The fatty acids forming the polyglycerol fatty acid ester are not particularly limited as long as they are fatty acids derived from animal and vegetable fats and oils that are edible. Example thereof include caprylic acid, capric acid, lauric acid, myristic acid, palmitic acid, stearic acid, oleic acid, linoleic acid, erucic acid, etc. The fatty acids may be one of the above fatty acids or a mixture of two or more of them, but preferably the fatty acids are a fatty acid or fatty acid mixture comprising one or more selected from the group consisting of caprylic acid, capric acid and lauric acid in an amount of about 50% by mass or more, preferably about 70% by mass or more, further more preferably about 90% by mass or more based on the total amount of the fatty acid or fatty acid mixture.

The propylene glycol fatty acid ester is a product of the esterification of propylene glycol with fatty acids, and is produced by an esterification reaction etc. in accordance with a known method, a conventional method or an equivalent method thereof. The ester may be a monoester, a diester, or a mixture thereof, but preferred is a diester. When the ester is a mixture of a monoester and a diester, the mixture preferably comprises a diester in an amount of about 50% by mass or more, preferably about 80% by mass or more, and more preferably 90% by mass or more.

The sorbitan fatty acid ester is a product of the esterification of sorbitol or sorbitan with fatty acids, and is produced by a known esterification reaction etc.

The fatty acids forming the propylene glycol fatty acid ester or the sorbitan fatty acid ester are not particularly limited as long as they are fatty acids derived from animal and vegetable fats and oils that are edible. Example thereof include one selected from the group of caprylic acid, capric acid, lauric acid, myristic acid, palmitic acid, stearic acid, oleic acid, linoleic acid, erucic acid, etc., and a mixture of two or more of them. Preferably, the fatty acids are a fatty acid or fatty acid mixture comprising one or more selected from the group of caprylic acid, capric acid and lauric acid in an amount of about 50% by mass or more, preferably about 70% by mass or more, further more preferably about 90% by mass or more based on the total amount of the fatty acid or fatty acid mixture.

The coagulant composition for tofu of the present invention may optionally comprise a sugar, a sugar alcohol or a polyalcohol. The use of a sugar, a sugar alcohol or a polyalcohol may prevent the sedimentation, separation, etc. of the inorganic salt coagulant contained in the coagulant composition for tofu, and may improve the stability of the composition.

Examples of the sugar include monosaccharides such as xylose, glucose and fructose; oligosaccharides such as sucrose, lactose and maltose; amylolysis products such as dextrin and starch syrup; maltooligosaccharides such as maltotriose, maltotetraose, maltopentaose and maltohexaose; etc. Examples of the sugar alcohol include sorbitol, mannitol, maltitol, reduced starch syrup, etc. Examples of the polyalcohol include propylene glycol, glycerol, polyglycerol, etc.

The above-exemplified sugars, sugar alcohols and polyalcohols may be used alone or in combination of two or more of them. Preferred is use of a polyalcohol alone. The sugars, the sugar alcohols and the polyalcohols may be in the form of a solution in which they are dissolved in or mixed with a solvent such as water. When any of the sugars, the sugar alcohols and the polyalcohols is dissolved in or mixed with a solvent, the ratio of the sugars etc. to the solvent may vary with the types of sugars etc. to be used. However, when glycerol is used, the amount of glycerol relative to 1 part by mass of water is about 1 to 20 parts by mass, preferably about 2 to 15 parts by mass, and further more preferably about 5 to 10 parts by mass.

In the Examples described later, a combination of dextrin and glycerol is used in the composition. However, the coagulant composition for tofu of the present invention is not required to comprise a sugar, a sugar alcohol or a polyalcohol, provided that the composition is storage stable.

If desired, the coagulant composition for tofu of the present invention may further comprise water as appropriate, but the addition of water is not essential.

The amount of each component in 100% by mass of the coagulant composition for tofu of the present invention is as follows:

(a) the inorganic salt coagulant is preferably about 16.5 to 70% by mass, more preferably about 18.5 to 50% by mass, further more preferably about 18.5 to 33% by mass, as calculated on the anhydrous basis;
(b) the polyglycerol ester of interesterified ricinoleic acid is preferably about 1 to 10% by mass, more preferably about 2 to 6% by mass;
(c) the lecithin is preferably about 0.5 to 7% by mass, more preferably about 1 to 5% by mass, and/or the diacetyltartaric and fatty acid ester of glycerol is about 0.01 to 5% by mass, more preferably about 0.1 to 3% by mass; and
(d) the oil component is about 15 to 78% by mass, more preferably about 30 to 73% by mass.

When component (c) comprises the lecithin and the diacetyltartaric and fatty acid ester of glycerol, the total amount of component (c) in the composition is about 0.01 to 7% by mass, more preferably about 0.1 to 5% by mass.

When the coagulant composition for tofu of the present invention comprises one or more selected from the group consisting of sugars, sugar alcohols and polyalcohols, the total amount of the sugars, the sugar alcohols and the polyalcohols in 100% by mass of the coagulant composition for tofu is about 1 to 20% by mass, preferably about 5 to 15% by mass.

The coagulant composition for tofu of the present invention may comprise a known additive to the extent that it does not impair the objects of the present invention. The additive is not particularly limited and examples thereof include thickeners such as starch, agar-agar and gelatin. Examples of the starch include corn starch, potato starch, wheat starch, rice starch, sweet potato starch, tapioca starch, mung bean starch, etc. Modified starches are also included and examples thereof include esterified starches (e.g., phosphate-crosslinked starches etc.), oxidized starches (e.g., dialdehyde starches etc.), and modified starches processed by esterification, oxidation, moist heat treatment, or the like, or by a combination thereof.

The coagulant composition for tofu of the present invention is produced by mixing the above components. The device used to produce the coagulant composition for tofu of the present invention is not particularly limited, and a usual stirring-mixing tank equipped with, for example, a stirrer, a heating jacket, or a baffle plate can be used. The stirrer used is, for example, a propeller stirrer, a high-speed rotary homogenizer (e.g., TK homomixer (PRIMIX Corporation), CLEARMIX (M Technique Co., Ltd), etc.), etc. Preferred is CLEARMIX. The resulting dispersion produced by stirring with a stirrer is preferably fed to a wet grinder etc. so that the particles of the inorganic salt coagulant in the dispersion is pulverized to fine particles. A wet grinder is a machine for pulverizing particles contained in a dispersion using grinding media, such as glass beads and zirconia beads, placed in the grinding chamber of the grinder. Examples of the wet grinder include a sand mill (Sintokogio, Ltd.), a bead mill (Finetec, Ltd.), and a dyno-mill (WAB AG, Switzerland), and these are suitable for the production.

The maximum particle diameter of the inorganic salt coagulant to be pulverized and contained in the coagulant composition for tofu of the present invention is preferably about 50 μm or less, more preferably about 40 μm or less, further more preferably about 30 μm or less. The pulverized particles of the inorganic salt coagulant efficiently adsorb other components in the coagulant composition to their surfaces. Consequently, when the coagulant composition for tofu of the present invention is added to and mixed with soy milk at the time of tofu making, the fine particles of the inorganic salt coagulant homogeneously disperse in the soy milk and then gradually and homogeneously dissolve in the soy milk to allow the coagulation of the soy milk to proceed. Due to this effect, the resulting tofu has smooth and homogeneous texture inside, contains a large amount of water and provides excellent mouthfeel. The pulverization of the inorganic salt coagulant also exhibits the effect of inhibiting the occurrence of sedimentation of the inorganic salt coagulant itself.

The maximum particle diameter of the inorganic salt coagulant may be determined by a conventional method in this field, and the method is not particularly limited. The maximum particle diameter may be determined by, for example, dispersing the inorganic salt coagulant in a liquid fat or oil (e.g., rapeseed oil, medium-chain fatty acid oil, or the like) at normal temperature, and measuring the particle diameter using a laser scattering particle distribution analyzer (model: LA-920, Horiba, Ltd.). As long as the maximum particle diameter determined by any given method falls within the above range, the particles are included in the technical scope of the present invention.

The production process of the coagulant composition for tofu of the present invention is not particularly limited, and the coagulant composition may be produced by a known process, a conventional process or an equivalent process thereof. Preferred embodiments of the production process of the coagulant composition for tofu will be exemplified below. The amounts, types, etc. of the components may be the same as described above.

In one embodiment of the present invention, for example, to (d) the oil component are added (b) the polyglycerol ester of interesterified ricinoleic acid and (c) the lecithin and/or the diacetyltartaric and fatty acid ester of glycerol. The mixture is heated to about 50 to 80° C., preferably to about 60 to 70° C. While the heated mixture is stirred, (a) the inorganic salt coagulant is added thereto. The mixture is stirred using a homogenizer etc. for about 10 to 60 minutes to give a dispersion in which preferably the inorganic salt coagulant is homogeneously dispersed. If desired, the dispersion is pulverized with a wet grinder etc. Thus, the coagulant composition for tofu of the present invention is produced.

More specifically, to a propylene glycol fatty acid ester are added the polyglycerol ester of interesterified ricinoleic acid together with the lecithin or the diacetyltartaric and fatty acid ester of glycerol. The mixture is heated to about 50 to 80° C., preferably to about 60 to 70° C. While the heated mixture is stirred, the inorganic salt coagulant (e.g., magnesium chloride) is added thereto, and then, if desired, a sugar, a sugar alcohol and/or a polyalcohol, in particular, glycerol, a mixed solution of glycerol and water (e.g., glycerol:water=about 9:1), or the like is added. The mixture is stirred using a high-speed rotary homogenizer etc, at a rotational speed of about 6,000 to 20,000 rpm for about 10 to 60 minutes to give a dispersion in which the inorganic salt coagulant is homogeneously dispersed. The dispersion can be pulverized preferably with a wet grinder etc. to give the coagulant composition for tofu of the present invention. The thus produced coagulant composition for tofu of the present invention is a homogeneous and stable composition in which the fine particles (particle diameter: about 0.01 to 50 μm) of the inorganic salt coagulant are ultra-finely dispersed.

Another embodiment of the production process of the coagulant composition for tofu, in which the inorganic salt coagulant is dissolved in water and the solution is emulsified and dried to give the coagulant composition for tofu, will be described below.

To (d) the oil component are added (b) the polyglycerol ester of interesterified ricinoleic acid and (c) the lecithin and/or the diacetyltartaric and fatty acid ester of glycerol, and the mixture is stirred. The oil-phase mixture is heated to about 50 to 80° C., preferably to about 60 to 70° C. Separately, to the inorganic salt coagulant are added water and, if desired, an additive such as glycerol, and the mixture is stirred. The aqueous-phase mixture is heated to about 50 to 80° C., preferably to about 60 to 70° C. The aqueous-phase mixture and the above-prepared oil-phase mixture are emulsified to form a water-in-oil type emulsion (hereinafter also simply called a water-in-oil emulsion). The emulsifying method is not particularly limited and the emulsification may be performed by, for example, gradually adding the aqueous-phase mixture to the oil-phase mixture with stirring using a homogenizer (e.g., a high-speed rotary homogenizer) etc. The water-in-oil type emulsion is dried to give the coagulant composition in dry state for tofu.

More specifically, to a propylene glycol fatty acid ester are added the polyglycerol ester of interesterified ricinoleic acid together with the lecithin and/or the diacetyltartaric and fatty acid ester of glycerol, and the mixture is stirred. The resulting oil phase is heated to about 50 to 80° C., preferably to about 60 to 70° C. Separately, to the inorganic salt coagulant are added water, glycerol, etc., and the mixture is stirred. The resulting aqueous phase is heated to about 50 to 80° C., preferably to about 60 to 70° C. The aqueous phase and the oil phase are emulsified by gradually adding the aqueous phase to the oil phase with stirring at 8,000 to 10,000 rpm using a high-speed rotary homogenizer (e.g., TK homomixer) etc. to give a water-in-oil emulsion. The water-in-oil emulsion is dried to give the coagulant composition for tofu of the present invention.

The production process of tofu using the coagulant composition for tofu of the present invention is also included in the present invention. The production process of tofu of the present invention comprises adding the coagulant composition for tofu of the present invention to hot soy milk, and dispersing the coagulant composition for tofu in the hot soy milk with a motionless mixer also called an in-line mixer (e.g., a static mixer etc.) or a low-speed stirrer to give a hot soy milk mixture. Since the coagulant composition for tofu of the present invention has high dispersibility in hot soy milk, the coagulant composition does not require the use of a high-speed stirrer, which is conventionally used for the dispersion of coagulants, and the coagulant composition is dispersed in hot soy milk merely with a motionless mixer, such as a static mixer, or a low-speed stirrer. Thus the coagulant composition exhibits very excellent effects in a production process of tofu using hot soy milk.

The hot soy milk used in the present invention is not particularly limited, and may be any hot soy milk as long as it is produced by a known method, a conventional method or an equivalent method thereof. Examples of the hot soy milk used in the present invention include hot soy milk with a solid content of usually about 9 to 15% by mass. The temperature of the hot soy milk used in the present invention is about 50 to 90° C., and soy milk with this temperature range is called “hot soy milk” in the present invention.

The solid content in the hot soy milk can be determined using, for example, a soy milk densitometer (model: PAL-27S, produced by ATAGO Co., Ltd.).

The addition of the coagulant composition for tofu of the present invention to the hot soy milk can be carried out by any method, and may be done by, for example, (I) adding a predetermined amount of the coagulant composition for tofu to a fixed amount of the hot soy milk placed in a container, or (II) flowing the hot soy milk through a pipeline at a constant rate using a pump etc. and continuously feeding a predetermined amount of the coagulant composition for soy milk into the pipeline in which the hot soy milk is flowing (this method is used, for example, in cases where a motionless mixer is used to mix the hot soy milk and the coagulant composition for tofu).

The static mixer used in the production process of tofu of the present invention is a motionless mixer (in-line mixer) without moving parts. Examples thereof include a static mixer comprising a cylindrical tube in which a fluid flows, and one or more ribbon-like helical elements for fluid mixing disposed in the tube. The static mixer comprises one or more, preferably a large number of the elements in the tube to achieve thorough mixing. Commercially available static mixers that may be used are, for example, those produced by NORITAKE CO., LIMITED (model: 1-N33-131-F etc.) and those produced by Japan Flow Controls Co., Ltd. (model: 100-806 etc.), but are not limited thereto.

The low-speed stirrer used in the production process of tofu of the present invention is, for example, a device that employs a rotor blade for mixing and stirring. The shape of the rotor blade of the device for mixing and stirring is not particularly limited and, for example, a paddle type blade, a propeller type blade, a ribbon type blade, a screw type blade, a turbine type blade, etc. can be used. Commercially available low-speed stirrers that may be used are, for example, those produced by Satake Chemical Equipment Mfg Ltd. (model: Satake Portable Mixer A630 etc.) and those produced by Shinei Kagaku Kikai Co., Ltd. (model: DTD-0.2 etc.), but are not limited thereto.

In one embodiment of the present invention, the phrase “stirring with a low-speed stirrer” refers to for example, stirring that produces a stirring effect equivalent to that produced by stirring with a TK homomixer at about 2,500 rpm or less. Preferably, the stirring is equivalent to stirring with a TK homomixer at about 2,000 rpm or less.

In the production process of tofu of the present invention, the coagulant composition for tofu and hot soy milk can be mixed not using a high-speed stirrer but using a motionless mixer, such as a static mixer, or a low-speed stirrer to prepare a hot soy milk mixture containing the coagulant composition for tofu dispersed therein.

When the temperature of the hot soy milk at the time of the addition of the coagulant composition for tofu to prepare the hot soy milk mixture is about 70° C. or higher, the resulting hot soy milk mixture is allowed to stand at about 70° C. or higher to coagulate into tofu. When the temperature of the hot soy milk at the time of the addition of the coagulant composition for tofu is lower than about 70° C., the resulting hot soy milk mixture is heated to about 70° C. or higher and then allowed to stand to coagulate into tofu.

An embodiment of the production process of tofu of the present invention may be in accordance with a known or conventional production process that is commonly used to produce silken tofu or an equivalent production process thereof. The production process of silken tofu varies with the type and size of the manufacturing equipment to be used and hence the production process is not particularly limited. A specific production process of the present invention is exemplified as follows.

The coagulant composition for tofu of the present invention is added to hot soy milk so that the amount of the inorganic salt coagulant (as calculated on the anhydrous basis) contained in the coagulant composition is preferably about 0.047 to 0.45 parts by mass, more preferably about 0.094 to 0.38 parts by mass relative to 100 parts by mass of the hot soy milk. The hot soy milk is stirred using a low-speed stirrer for about 10 to 20 seconds to give a hot soy milk mixture. The mixture is then poured into a mold. When the temperature of the hot soy milk at the time of the addition of the coagulant composition for tofu is lower than about 70° C., the mold containing the hot soy milk mixture is heated in a hot water bath etc. to allow the hot soy milk mixture to be heated to 70° C. or higher and to coagulate into silken tofu, and the silken tofu is cut into an appropriate size. When the temperature of the hot soy milk at the time of the addition of the coagulant composition for tofu is about 70° C. or higher, the mold containing the hot soy milk mixture is left to stand for about 20 minutes without heating to allow the hot soy milk mixture to coagulate into silken tofu, and the silken tofu is cut into an appropriate size. The thus produced silken tofu is usually cooled to about 5° C.

As in the above manner, the coagulant composition for tofu is mixed with hot soy milk without high-speed stirring, and a well-textured silken tofu is obtained.

Another embodiment of the production process of tofu of the present invention may be in accordance with a known or conventional production process that is commonly used to produce packed silken tofu (juten-dofu) or an equivalent production process thereof. In the production process of packed silken tofu using the coagulant composition for tofu of the present invention, conventional manufacturing equipment for packed silken tofu equipped with, for example, a motionless mixer such as a static mixer can be used without any modifications. Accordingly, there is no need for newly installing additional equipment, for example, a high speed stirrer etc., in existing facilities for the purpose of mixing the coagulant composition for tofu in hot soy milk. In addition, since the coagulant composition for tofu can be added to hot soy milk in the production process of the present invention, there is also no need for cooling of hot soy milk (for example, the step of cooling hot soy milk to 15° C. or lower to prepare cold soy milk), which is usually carried out in a conventional production process of packed silken tofu. For these reasons, the production process of the present invention is more excellent in the energy efficiency and production efficiency than the conventional production process.

The production process of packed silken tofu varies with the type and size of the manufacturing equipment to be used and hence the production process is not particularly limited. A specific production process of the present invention is exemplified as follows.

Hot soy milk is flowed through a pipeline using a pump etc., and a predetermined amount of the coagulant composition for tofu is continuously fed into the pipeline in which the hot soy milk is flowing. The flow rate of the hot soy milk varies with the output rate of the production line of packed silken tofu and with the performance of the downstream machines, such as a filling machine, a packaging machine, and a boiling and cooling tank, and can be adjusted as appropriate. The amount of the coagulant composition for tofu added to the hot soy milk is not particularly limited as long as the effects of the present invention are exhibited. For example, the coagulant composition for tofu of the present invention is added to hot soy milk so that the amount of the inorganic salt coagulant (as calculated on the anhydrous basis) contained in the coagulant composition is preferably about 0.047 to 0.45 parts by mass, more preferably about 0.094 to 0.38 parts by mass relative to 100 parts by mass of the hot soy milk.

The coagulant composition for tofu that has been added to the hot soy milk is dispersed with a static mixer. The resulting hot soy milk mixture is poured into a container until full and the container is sealed. The time from the addition of the coagulant composition for tofu to the hot soy milk to pouring in the container is not particularly limited, but preferably the pouring is carried out within about five minutes from the addition because the hot soy milk should be poured into the container before it coagulates.

When the temperature of the hot soy milk at the time of the addition of the coagulant composition for tofu is lower than about 70° C., the sealed container containing the hot soy milk mixture is soaked in a hot water bath etc. to allow the hot soy milk mixture to be heated to about 70° C. or higher and to coagulate to give packed silken tofu. When the temperature of the hot soy milk at the time of the addition of the coagulant composition for tofu is about 70° C. or higher, the sealed container containing the hot soy milk mixture is left to stand for about 20 minutes without heating to allow the hot soy milk mixture to coagulate to give packed silken tofu. The packed silken tofu may be further heated for sterilization. The heating for sterilization may be performed in accordance with a conventional method in this field. The thus produced packed silken tofu is usually cooled to about 5° C.

### EXAMPLES

The present invention will be described below with reference to Examples. The Examples are, however, provided for illustrative purposes only and the present invention is not limited thereto.

### Production Example 1

### Production of Propylene Glycol Fatty Acid Esters of Component (d)

To a 20 L reaction vessel equipped with a stirrer, a thermometer, a gas inlet tube and a water separator were fed 2,700 g of propylene glycol and 12,300 g of a mixed fatty acid of capric acid and lauric acid (the mass mixing ratio of capric acid and lauric acid was 60:40). Esterification reaction was performed under nitrogen gas flow at 160 to 220° C. for 6 hours, during which the generated water was removed from the system. At the end of the reaction, the liquid temperature was raised to 235° C., and free fatty acids were removed under reduced pressure (about 3 KPa) to reduce the acid value to 8 or less. The resulting reaction mixture was fed to a centrifugal molecular distillation still and the residual fatty acids and propylene glycol fatty acid monoesters were evaporated off at 140 to 190° C. under a vacuum pressure of 80 Pa. The mixture was distilled at 210° C. under a pressure of 30 Pa to give about 3,300 g of a propylene glycol fatty acid ester fraction. The fraction had an acid value of 0.6 and contained about 95% by mass or more of propylene glycol fatty acid diesters.

### Production of Coagulant Compositions for Tofu

### Example 1

A coagulant composition for tofu was produced using 60-fold amounts of the ingredients shown in Table 1. Briefly, to the propylene glycol fatty acid esters were added polyglycerol esters of interesterified ricinoleic acid (trade name: Palsgaard 4110, produced by Palsgaard A/S), magnesium chloride hexahydrate (trade name: White Nigari, produced by Naruto Salt Mfg. Co., Ltd.), a lecithin (trade name: Yelkin TS, produced by ADM Company), glycerol (trade name: Glycerin, produced by Eiken Shoji Co., Ltd.) and dextrin (trade name: Cluster Dextrin, produced by Ezaki Glico Co., Ltd.). The mixture was stirred at 10,000 rpm at about 70 to 80° C. for 20 minutes with a TK homomixer (model: TK HOMOMIXER MARK II, PRIMIX Corporation). The stirred mixture was passed through a dyno-mill (model: DYNO-MILL (WAB AG, Switzerland) using 1.5 mm zirconia beads (WAB AG, Switzerland)) at about 30 to 50° C. three times to give a coagulant composition for tofu (Example product 1). The magnesium chloride content of the composition was 23.4% by mass as calculated on anhydrous magnesium chloride basis [ (50/203.3)×95.21].

### Example 2

A coagulant composition for tofu (Example product 2) was produced in the same manner as in Example 1 except that an enzymatically hydrolyzed lecithin (trade name: SLP White Lyso, produced by Tsuji Oil Mills Co., Ltd.) was used instead of the lecithin.

### Example 3

A coagulant composition for tofu (Example product 3) was produced in the same manner as in Example 1 except that diacetyltartaric and fatty acid esters of glycerol 1 (trade name: Poem W-60, Riken Vitamin Co., Ltd.) were used instead of the lecithin.

### Example 4

A coagulant composition for tofu (Example product 4) was produced in the same manner as in Example 1 except that diacetyltartaric and fatty acid esters of glycerol 2 (trade name: PANODAN AB-100VEGFS, produced by Danisco A/S) were used instead of the lecithin.

### Example 5

A coagulant composition for tofu (Example product 5) was produced in the same manner as in Example 1 except that diacetyltartaric and fatty acid esters of glycerol 2 (trade name: PANODAN AB-100VEGFS, produced by Danisco A/S) were used instead of the lecithin.

### Comparative Example 1

A coagulant composition for tofu (Comparative example product 1) was produced in the same manner as in Example 1 except that glycerol fatty acid esters (trade name: Poem OL-200V, Riken Vitamin Co., Ltd.) were used instead of the lecithin.

### Comparative Example 2

A coagulant composition for tofu (Comparative example product 2) was produced in the same manner as in Example 1 except that citric and fatty acid esters of glycerol (trade name: K-37V, Riken Vitamin Co., Ltd.) were used instead of the lecithin.

### Comparative Example 3

A coagulant composition for tofu (Comparative example product 3) was produced in the same manner as in Example 1 except that sorbitan fatty acid esters (trade name: O-80V, Riken Vitamin Co., Ltd.) were used instead of the lecithin.

### Comparative Example 4

A coagulant composition for tofu (Comparative example product 4) was produced in the same manner as in Example 1 except that the lecithin was not used.

TABLE 1

| | Example | | | | | Comparative Example | | | |
|---|---|---|---|---|---|---|---|---|---|
| | 1 | 2 | 3 | 4 | 5 | 1 | 2 | 3 | 4 |
| Magnesium chloride | 50.0 | 50.0 | 50.0 | 50.0 | 50.0 | 50.0 | 50.0 | 50.0 | 50.0 |
| hexahydrate | | | | | | | | | |
| Polyglycerol esters of | 2.0 | 2.0 | 2.0 | 2.0 | 2.0 | 2.0 | 2.0 | 2.0 | 2.0 |
| interesterified ricinoleic acid | | | | | | | | | |
| Propylene glycol fatty acid | 33.4 | 35.9 | 35.9 | 36.6 | 36.8 | 35.9 | 35.9 | 35.9 | 37.2 |
| esters | | | | | | | | | |
| Lecithin | 3.8 | — | — | — | — | — | — | — | — |
| Enzymatically hydrolyzed | — | 1.3 | — | — | — | — | — | — | — |
| lecithin | | | | | | | | | |
| Diacetyltartaric and fatty | — | — | 1.3 | — | — | — | — | — | — |
| acid esters of glycerol 1 | | | | | | | | | |
| Diacetyltartaric and fatty | — | — | — | 0.6 | 0.4 | — | — | — | — |
| acid esters of glycerol 2 | | | | | | | | | |
| Glycerol fatty acid esters | — | — | — | — | — | 1.3 | — | — | — |
| Citric and fatty acid esters of | — | — | — | — | — | — | 1.3 | — | — |
| glycerol | | | | | | | | | |
| Sorbitan fatty acid esters | — | — | — | — | — | — | — | 1.3 | — |
| Dextrin | 4.1 | 4.1 | 4.1 | 4.1 | 4.1 | 4.1 | 4.1 | 4.1 | 4.1 |
| Glycerol | 6.7 | 6.7 | 6.7 | 6.7 | 6.7 | 6.7 | 6.7 | 6.7 | 6.7 |

The values in the table are expressed in terms of mass (g).

### Evaluation of Coagulant Compositions for Tofu Through Production of Silken Tofus

The coagulant compositions for tofu produced in Examples 1 to 5 and Comparative Examples 1 to 4 (Example products 1 to and Comparative example products 1 to 4) were used to produce silken tofus and, during the production, the following tests were performed. In particular, the coagulating effect and the mouthfeel were tested on the silken tofus.

### Production of Silken Tofus

Into a 300 mL beaker was poured 250 g of hot soy milk (Brix: 12) at 85° C. and the temperature was maintained at 85° C. While the hot soy milk was stirred at about 500 rpm using a low-speed stirrer, Three-one Motor (mode: BL-1200, equipped with a Ø 70 Soft Cross type impeller, produced by Shinto Scientific Co., Ltd.), each of the coagulant compositions for tofu (each of Example products 1 to 5 and Comparative example Products 1 to 4) was separately added to the hot soy milk so that the amount of each coagulant composition relative to 100 parts by mass of the hot soy milk was 0.6 parts by mass [0.14 parts by mass in terms of the inorganic salt coagulant (as calculated on the anhydrous basis)]. When the hot soy milk started to coagulate, the stirring was stopped, and the hot soy milk was left to stand for 20 minutes and then cooled to 5° C. in ice water. Thus, silken tofus (Samples 1 to 9) were produced.

### Evaluation of Coagulating Effect: Determination of Coagulation Time

The coagulation time of the hot soy milk was defined as the time period from the addition of each coagulant composition to the start of coagulation, and was determined during the production of the silken tofus. In cases where the coagulation start time is 5 to 300 seconds, the coagulant composition is sufficiently effective in actual production. In cases where the coagulation start time is 10 to 250 seconds, the coagulant composition is further effective. When coagulation did not start even after 5 minutes had passed, the coagulation start time was judged to be unmeasurable. The results of the determination of the coagulation time are shown in Table 3.

### Evaluation of Coagulating Effect: Degree of Coagulation

The degree of the coagulation of the produced silken tofus was examined by visual observation. The evaluation was conducted by ten panelists in accordance with the evaluation criteria shown in Table 2 below. The scores given by the ten panelists were averaged and graded in accordance with the following criteria. The results are shown in Table 3.

### Grading

A: a mean value of 2.5 or more

B: a mean value of 1.5 or more and less than 2.5

C: a mean value of less than 1.5

### Evaluation of Mouthfeel of Silken Tofus

Sensory analysis for the mouthfeel was performed on the silken tofus that were subjected, during the production, to the above evaluation of the coagulating effect and determination of the coagulation time.

The sensory analysis was conducted by ten panelists in accordance with the evaluation criteria shown in Table 2 below. The scores given by the ten panelists were averaged and graded in accordance with the criteria described in the above section, Evaluation of coagulating effect: degree of coagulation. The results are shown in Table 3.

TABLE 2

| Evaluation item | Evaluation criteria | Score |
|---|---|---|
| Degree of | The soy milk thoroughly coagulated and | 3 |
| coagulation of | formed into tofu with appropriate hardness. | |
| soy milk | The soy milk thoroughly coagulated but | 2 |
| | remained soft and jelly like. | |
| | The soy milk partially coagulated, or did | 1 |
| | not coagulate at all and remained liquid. | |
| Mouthfeel of | The tofu had smooth texture inside with | 3 |
| tofu | soft mouthfeel. | |
| | The tofu had rather rough texture inside | 2 |
| | and lacked soft mouthfeel. | |
| | The soy milk did not coagulate and thus | 1 |
| | was not evaluated. | |

TABLE 3

| | Coagulant | Coagulation | Degree of | Mouth- |
|---|---|---|---|---|
| | composition | start time | coagulation | feel |
| Sample | for tofu | (sec) | of tofu | of tofu |
| Sample 1 | Example product 1 | 185 | A | A |
| Sample 2 | Example product 2 | 84 | A | A |
| Sample 3 | Example product 3 | 12 | A | A |
| Sample 4 | Example product 4 | 53 | A | A |
| Sample 5 | Example product 5 | 240 | A | A |
| Sample 6 | Comparative example | Unmea- | C | C |
| | product 1 | surable | | |
| Sample 7 | Comparative example | Unmea- | C | C |
| | product 2 | surable | | |
| Sample 8 | Comparative example | Unmea- | C | C |
| | product 3 | surable | | |
| Sample 9 | Comparative example | Unmea- | C | C |
| | product 4 | surable | | |

As is apparent from the results, in the cases of Samples 1 to 5 using Example products 1 to 5, the coagulant compositions for tofu were thoroughly dispersed in the soy milk merely by low-speed stirring, and the soy milk started to coagulate within 240 seconds, resulting in thorough coagulation to give silken tofus. The degree of coagulation and the mouthfeel of the tofus were favorable.

In contrast, in the cases of Samples 6 to 9 using Comparative example products 1 to 4, the coagulant compositions for tofu were not thoroughly dispersed in the soy milk by low-speed stirring, and the soy milk did not thoroughly coagulate even after 5 minutes had passed, failing to give a silken tofu.

### Evaluation of Coagulant Compositions for Tofu Through Production of Packed Silken Tofus 1

### Production of Packed Silken Tofus 1

Into a 3 L stainless steel beaker was poured 2,500 g of hot soy milk (Brix: 12). The hot soy milk, while maintained at the temperature shown in Table 4 below, was fed, at a rate of 1,650 g/min, to a static mixer (model: 1/4-N30-232-F, produced by NORITAKE CO., LIMITED) using a tube pump (model: TPK-2000, produced by Sanshin Co., Ltd.). Just upstream of the static mixer, each of the coagulant compositions for tofu (each of Example products 1 to 5 and Comparative example Products 1 to 4) was separately and continuously fed to the hot soy milk so that the amount of each coagulant composition relative to 100 parts by mass of the hot soy milk was 0.6 parts by mass [0.14 parts by mass in terms of the inorganic salt coagulant (as calculated on the anhydrous basis)]. The hot soy milk mixture that had passed through the static mixer was poured into a container (product name: 88-120M Shibo, material: PP, size: 88 mm diameter×32.5 mm, produced by Shingi Corporation) until full. The top of the container was sealed with a film. The sealed hot soy milk mixture was heated (in a hot water at 80° C. for 40 minutes) and then cooled to 5° C. in ice water. Thus, packed silken tofus (Samples 10 to 18) were produced.

### Evaluation of Coagulating Effect: Degree of Coagulation

The degree of the coagulation of the packed silken tofus produced in the above was examined by visual observation. The evaluation was performed in the same manner as in the above “Evaluation of coagulant compositions for tofu through production of silken tofus”. The results are shown in Table 4.

### Evaluation of Mouthfeel of Packed Silken Tofus

Sensory analysis for the mouthfeel was performed on the packed silken tofus produced above. The sensory analysis was conducted in the same manner as in the above “Evaluation of coagulant compositions for tofu through production of silken tofus”. The results are shown in Table 4.

TABLE 4

| | Coagulant | Temper- | Degree of | Mouth- |
|---|---|---|---|---|
| | composition | ature of | coagulation | feel |
| Sample | for tofu | hot soy milk | of tofu | of tofu |
| Sample 10 | Example product 1 | 80° C. | A | A |
| Sample 11 | Example product 2 | 70° C. | A | A |
| Sample 12 | Example product 3 | 50° C. | A | A |
| Sample 13 | Example product 4 | 60° C. | A | A |
| Sample 14 | Example product 5 | 90° C. | A | A |
| Sample 15 | Comparative example | 50° C. | C | C |
| | product 1 | | | |
| Sample 16 | Comparative example | 70° C. | C | C |
| | product 2 | | | |
| Sample 17 | Comparative example | 80° C. | C | C |
| | product 3 | | | |
| Sample 18 | Comparative example | 98° C. | C | C |
| | product 4 | | | |

The results show that as a result of adding any of Example products as a coagulant composition for tofu to hot soy milk at 50° C. or higher, dispersing the coagulant composition in the hot soy milk using a static mixer instead of a high-speed stirrer, pouring the hot soy milk mixture in a container until full and heating the packed mixture, the hot soy milk mixture thoroughly coagulated to give a packed silken tofu with good mouthfeel that is equal to or better than that of packed silken tofus produced by the conventional method.

In contrast, when any of Comparative example products was added as a coagulant composition for tofu to hot soy milk at 50° C. or higher and mixed with a static mixer, the coagulant composition for tofu was not dispersed in the hot soy milk, and the hot soy milk mixture did not thoroughly coagulate, failing to give a packed silken tofu.

### Evaluation of Coagulant Compositions for Tofu Through Production of Packed Silken Tofus 2

### Production of Packed Silken Tofus 2

Into a 3 L stainless steel beaker was poured 2,500 g of hot soy milk (Brix: 12). The hot soy milk, while maintained at the temperature shown in Table 5 below, was fed, at a rate of 1,650 g/min, to a static mixer (model: 1/4-N30-232-F, produced by NORITAKE CO., LIMITED) using a tube pump (model: TPK-2000, produced by Sanshin Co., Ltd.). Just upstream of the static mixer, each of the coagulant compositions for tofu (each of Example products 1 to 5 and Comparative example Products 1 to 4) was separately and continuously fed to the hot soy milk so that the amount of each coagulant composition relative to 100 parts by mass of the hot soy milk was 0.6 parts by mass [0.14 parts by mass in terms of the inorganic salt coagulant (as calculated on the anhydrous basis)]. The hot soy milk mixture that had passed through the static mixer was poured into a container (product name: 88-120M Shibo, material: PP, size: 88 mm diameter×32.5 mm, produced by Shingi Corporation) until full. The top of the container was sealed with a film. The mixture was left to stand, without heating, at normal temperature for 20 minutes and then cooled to 5° C. in ice water. Thus, packed silken tofus (Samples 19 to 27) were produced.

### Evaluation of Coagulating Effect: Degree of Coagulation

The degree of the coagulation of the packed silken tofus produced in the above was examined by visual observation. The evaluation was performed in the same manner as in the above “Evaluation of coagulant compositions for tofu through production of silken tofus”. The results are shown in Table 5.

### Evaluation of Mouthfeel of Packed Silken Tofus

Sensory analysis for the mouthfeel was performed on the packed silken tofus produced above. The sensory analysis was conducted in the same manner as in the above “Evaluation of coagulant compositions for tofu through production of silken tofus”. The results are shown in Table 5.

TABLE 5

| | Coagulant | Temper- | Degree of | Mouth- |
|---|---|---|---|---|
| | composition | ature of | coagulation | feel |
| Sample | for tofu | hot soy milk | of tofu | of tofu |
| Sample 19 | Example product 1 | 80° C. | A | A |
| Sample 20 | Example product 2 | 70° C. | A | A |
| Sample 21 | Example product 3 | 75° C. | A | A |
| Sample 22 | Example product 4 | 80° C. | A | A |
| Sample 23 | Example product 5 | 90° C. | A | A |
| Sample 24 | Comparative example | 90° C. | C | C |
| | product 1 | | | |
| Sample 25 | Comparative example | 80° C. | C | C |
| | product 2 | | | |
| Sample 26 | Comparative example | 70° C. | C | C |
| | product 3 | | | |
| Sample 27 | Comparative example | 75° C. | C | C |
| | product 4 | | | |

The results show that as a result of adding any of Example products as a coagulant composition for tofu to hot soy milk at 70 to 90° C., dispersing the coagulant composition in the hot soy milk using a static mixer instead of a high-speed stirrer, pouring the hot soy milk mixture in a container until full and allowing the packed mixture to stand without heating, the hot soy milk mixture thoroughly coagulated to give a packed silken tofu with good mouthfeel that is equal to or better than that of packed silken tofus produced by the conventional method.

In contrast, when any of Comparative example products was added as a coagulant composition for tofu to hot soy milk at 70 to 90° C. or higher and mixed with a static mixer, the coagulant composition for tofu was not dispersed in the hot soy milk, and the hot soy milk mixture did not thoroughly coagulate, failing to give a packed silken tofu.

1. A coagulant composition for tofu, the composition comprising (a) an inorganic salt coagulant, (b) a polyglycerol ester of interesterified ricinoleic acid, (c) a lecithin and/or a diacetyltartaric and fatty acid ester of glycerol and (d) an oil component.

2. The coagulant composition for tofu according to claim 1, wherein the amount of (a) the inorganic salt coagulant relative to 100% by mass of the coagulant composition for tofu is from 16.5 to 70% by mass as calculated on the anhydrous basis.

3. A process for producing tofu, the process comprising adding the coagulant composition for tofu according to claim 1 to hot soy milk, and
dispersing the coagulant composition for tofu in the hot soy milk with a motionless mixer or a low-speed stirrer to give a hot soy milk mixture.

4. A process for producing tofu, the process comprising adding the coagulant composition for tofu according to claim 2 to hot soy milk, and
dispersing the coagulant composition for tofu in the hot soy milk with a motionless mixer or a low-speed stirrer to give a hot soy milk mixture.
